(19) United States
(12) Patent Application Publication
(10) Pub. No.: US 2026/0181636 A1
(43) Pub. Date: Jun. 25, 2026

(54) METHOD AND DEVICE FOR WIRELESS COMMUNICATION

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/180,246

(22) Filed: Apr. 16, 2025

Related U.S. Application Data
(63) Continuation of application No. PCT/CN2023/136173, filed on Dec. 4, 2023.

(51) Int. Cl. H04W 72/21; H04L 1/08; H04W 24/08; H04W 84/06

(52) U.S. Cl. CPC H04W 72/21; H04L 1/08; H04W 24/08; H04W 84/06

(57) ABSTRACT

A method and a device for wireless communication are provided according to the present disclosure. One example method includes the following steps: receiving, by a terminal device, a first message in a random access procedure; and repeatedly transmitting, by the terminal device, a physical uplink channel (PUCCH) using frequency hopping. The PUCCH is configured to carry feedback information of a message 4 (Msg4) corresponding to the first message. A first resource of the PUCCH is determined according to at least one of the following information: a number of repetition transmission of the PUCCH, or a first offset for repeatedly transmitting the PUCCH.

### CROSS-REFERENCE TO RELATED APPLICATIONS

This application is a continuation of International Application No. PCT/CN2023/136173, filed on Dec. 4, 2023, the disclosure of which is hereby incorporated by reference in its entirety.

### TECHNICAL FIELD

The present disclosure relates to the technical field of communication, and in particular to a method and a device for wireless communication.

### BACKGROUND

Some communication systems, such as non terrestrial network (NTN) systems, have large transmission delays. In a random access procedure of such communication systems, a terminal device can improve the uplink coverage through repeated transmission. For example, the terminal device can ensure the success rate of random access by repeatedly transmitting a physical uplink control channel (PUCCH) carrying the feedback information of message 4.

When repeated transmission of the PUCCH is introduced, how to allocate uplink resources of the PUCCH is an urgent problem to be solved.

### SUMMARY

A method and a device for wireless communication are provided according to embodiments of the present disclosure. Various aspects involved in the embodiments of the present disclosure are described below.

In a first aspect, a method for wireless communication is provided, which includes: receiving, by a terminal device, a first message in a random access procedure; and repeatedly transmitting, by the terminal device, a physical uplink channel (PUCCH) using frequency hopping. The PUCCH is configured to carry feedback information corresponding to the first message. A first resource of the PUCCH is determined according to at least one of the following information: number of transmission of the PUCCH; and a first offset for repeatedly transmitting the PUCCH.

In a second aspect, a method for wireless communication is provided, which includes: transmitting, by a network device, a first message in a random access procedure; receiving, by the network device, a physical uplink channel (PUCCH) repeatedly transmitted by a terminal device using frequency hopping. The PUCCH is configured to carry feedback information corresponding to the first message. A first resource of the PUCCH is determined according to at least one of the following information: number of transmission of the PUCCH; and a first offset for repeatedly transmitting the PUCCH.

In a third aspect, a device for wireless communication is provided, the device is a terminal device, and the device includes: a receiving unit, configured to receive a first message in a random access procedure; a transmitting unit, configured to repeatedly transmit a physical uplink channel (PUCCH) using frequency hopping. The PUCCH is configured to carry feedback information corresponding to the first message. A first resource of the PUCCH is determined according to at least one of the following information: number of transmission of the PUCCH; and a first offset for repeatedly transmitting the PUCCH.

In fourth aspect, a device for wireless communication, the device is a network device, and the device includes: a transmitting unit, configured to transmit a first message in a random access procedure; a receiving unit, configured to receive a physical uplink channel (PUCCH) repeatedly transmitted by a terminal device using frequency hopping. The PUCCH is configured to carry feedback information corresponding to the first message. A first resource of the PUCCH is determined according to at least one of the following information: number of transmission of the PUCCH; and a first offset for repeatedly transmitting the PUCCH.

In a fifth aspect, a communication device is provided, which includes a memory and a processor, the memory is configured to store a program, and the processor is configured to call the program from the memory to execute the method according to any one of the first aspect and the second aspect.

In a sixth aspect, a device is provided, which includes a processor configured to call a program from a memory, to execute the method according to any one of the first aspect and the second aspect.

In a seventh aspect, a chip is provided, which includes a processor, configured to call a program from a memory, to cause a device mounted with the chip executes the method according to any one of the first aspect and the second aspect.

In an eighth aspect, a computer-readable storage medium is provided, and a program is stored on the computer-readable storage medium, to cause a computer to execute the method according to any one of the first aspect and the second aspect.

In a ninth aspect, a computer program product is provided, which includes a program causing a computer to execute the method according to any one of the first aspect and the second aspect.

In a tenth aspect, a computer program is provided, which causes a computer to execute the method according to any one of the first aspect and the second aspect.

In the embodiments of the present disclosure, the terminal device uses frequency hopping to repeatedly transmit the PUCCH. The first resource for repeatedly transmitting the PUCCH is determined according to the number of transmission of the PUCCH and/or the first offset of for repeatedly transmitting the PUCCH. It can be seen that the embodiments of the present disclosure make it clear that the terminal device uses frequency hopping to repeatedly transmit the PUCCH. Further, the first resource of using frequency hopping for transmitting multiple identical PUCCHs is determined based on the actual transmission situation and/or configuration parameters of the PUCCH, thus improving the uplink coverage performance and improving the resource utilization rate.

### BRIEF DESCRIPTION OF THE DRAWINGS

FIG. 1 is a schematic diagram of a wireless communication system applied to an embodiment of the present disclosure.

FIG. 2 is a schematic diagram of an NTN system applied to an embodiment of the present disclosure.

FIG. 3 is a schematic diagram of another NTN system applied to an embodiment of the present disclosure.

FIG. 4 is a schematic flowchart of a random access procedure.

FIG. 5 is a schematic flowchart of a method for wireless communication provided by an embodiment of the present disclosure.

FIG. 6 is a schematic flowchart of a possible implementation of the method shown in FIG. 5.

FIG. 7 is a schematic structural diagram of a device for wireless communication provided by an embodiment of the present disclosure.

FIG. 8 is a schematic structural diagram of another device for wireless communication provided by an embodiment of the present disclosure.

FIG. 9 is a schematic structural diagram of a communication device provided by an embodiment of the present disclosure.

### DETAILED DESCRIPTION OF THE EMBODIMENTS

The technical solutions in the embodiments of the present disclosure will be described below in combination with the accompanying drawings in the embodiments of the present disclosure. Apparently, the described embodiments are part of the embodiments of the present disclosure, rather than all of them. For the embodiments in the present disclosure, all other embodiments obtained by those skilled in the art without creative efforts shall fall within the protection scope of the present disclosure.

The embodiments of the present disclosure may be applied to various communication systems. For example, the embodiments of the present disclosure may be applied to a global system of mobile communication (GSM) system, a code division multiple access (CDMA) system, a wideband code division multiple access (WCDMA) system, a general packet radio service (GPRS), a long term evolution (LTE) system, an advanced long-term evolution (LTE-A) system, a new radio (NR) system, an evolution systems of a NR system, a LTE-based access to unlicensed spectrum (LTE-U) system, an NR-based access to unlicensed spectrum (NR-U) system, a universal mobile telecommunication system (UMTS), wireless local area networks (WLAN), wireless fidelity (WiFi) and a 5th-generation (5G) system. The embodiments of the present disclosure may also be applied to other communication systems, such as future communication systems. The future communication system may be, for example, a 6th-generation (6G) mobile communication system, or a satellite communication system.

Conventional communication systems have a limited number of supported connections and are relatively easy to be implemented. However, with the development of communication technology, communication systems can support not only conventional cellular communication but also one or more other types of communication. For example, a communication system may support one or more of the following types of communication: device to device (D2D) communication, machine to machine (M2M) communication, machine type communication (MTC), vehicle to vehicle (V2V) communication, and vehicle to everything (V2X) communication. The embodiments of the present disclosure may also be applied to communication systems that support the above-mentioned communication modes.

The communication systems in the embodiments of the present disclosure may be applied to the carrier aggregation (CA) scenario, the dual connectivity (DC) scenario, and the standalone (SA) networking scenario.

The communication systems in the embodiments of the present disclosure may be applied to unlicensed spectrum. The unlicensed spectrum may also be regarded as shared spectrum. Alternatively, the communication systems in the embodiments of the present disclosure may be applied to licensed spectrum. The licensed spectrum may also be regarded as a dedicated spectrum.

The embodiments of the present disclosure may be applied to a terrestrial networks (TN) system, and may also be applied to an NTN system. As an example, the NTN system may include an NTN system based on 4G, an NTN system based on NR, an NTN system based on internet of things (IoT) and an NTN system based on narrow band internet of things (NB-IoT).

A communication system may include one or more terminal devices. The terminal device mentioned in the embodiments of the present disclosure may also be referred to as user equipment (UE), access terminal, user unit, user station, mobile station (MS), mobile Terminal (MT), remote station, remote terminal, mobile device, user terminal, terminal, wireless communication device, user agent or user device, etc.

In some embodiments, the terminal device may be a STATION (ST) in a WLAN. In some embodiments, the terminal device may be a cellular phone, a cordless phone, a session initiation protocol (SIP) phone, a wireless local loop (WLL) station, a personal digital assistant, PDA) device, a handheld device with wireless communication function, a computing device or other processing devices connected to wireless modems, a vehicle-mounted device, a wearable device, a terminal device in the next generation communication system (such as NR system), or a terminal device in the future evolved public land mobile network (PLMN).

In some embodiments, the terminal device may be a device that provides voice and/or data connectivity to a user. For example, the terminal device may be a handheld device with wireless connection function, a vehicle-mounted device, and the like. As some concrete examples, the terminal device may be a mobile phone, a Pad, a notebook computer, a personal digital assistant (PDA), a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, and a wireless terminal in smart home, etc.

In some embodiments, the terminal device may be deployed on land. For example, the terminal device may be deployed indoors or outdoors. In some embodiments, the terminal device may be deployed on the water surface, such as on a ship. In some embodiments, the terminal device may be deployed in the air, such as on an aircraft, a balloon, or a satellite.

In addition to the terminal device, the communication system may include one or more network devices. The network device in the embodiments of the present disclosure is a device for communicating with the terminal device, which be referred to as an access network device or a radio access network device. For example, the network device may be a base station. The network device in the embodiments of the present disclosure may refer to a radio access network (RAN) node (or device) that connects the terminal device to the wireless network. The base station may broadly cover various names as follows, or may be replaced with the following names, such as: NodeB, evolved NodeB (eNB), next generation NodeB (gNB), relay station, access point, transmitting and receiving Point (TRP), transmitting point (TP), master evolved NodeB (MeNB), secondary evolved NodeB (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node, etc. The base station may be a macro base station, a micro base station, a relay node, a donor node, or the like, or a combination thereof. The base station may also refer to a communication module, a modem, or a chip installed in the aforementioned device or equipment. The base station may also be a mobile switching center, a device that undertakes the functions of a base station in D2D, V2X, M2M communications, a network-side device in a 6G network, a device that undertakes the functions of a base station in a future communication system, etc. The base station may support networks with the same or different access technologies. The embodiments of the present disclosure do not limit the specific technology and specific device form adopted by the network device.

The base station may be fixed or mobile. For example, a helicopter or a drone can be configured as a mobile base station, and one or more cells can move according to the position of the mobile base station. In other examples, a helicopter or a drone may be configured as a device to communicate with another base station.

In some examples, the network device according to the embodiments of the present disclosure may be CU or DU, or the network device may include both CU and DU. gNB may further include AAU.

By way of example and not limitation, in the embodiments of the present disclosure, the network device may have mobility characteristics. For example, the network device may be a mobile device. In some embodiments of the present disclosure, the network device may be a satellite or a balloon station. In some other embodiments of the present disclosure, the network device may also be a base station located on land, in water areas, or other places.

In the embodiments of the present disclosure, the network device can provide services for a cell. The terminal device communicates with the network device through the transmission resources (such as frequency-domain resources, or spectrum resources) used by the cell. The cell may be a cell corresponding to the network device (such as a base station). The cell may belong to a macro base station or a base station corresponding to a small cell. Herein, the small cell may include metro cell, micro cell, pico cell, femto cell, etc. The small cells have the characteristics of small coverage area and low transmission power, and are suitable for providing high-rate data transmission services.

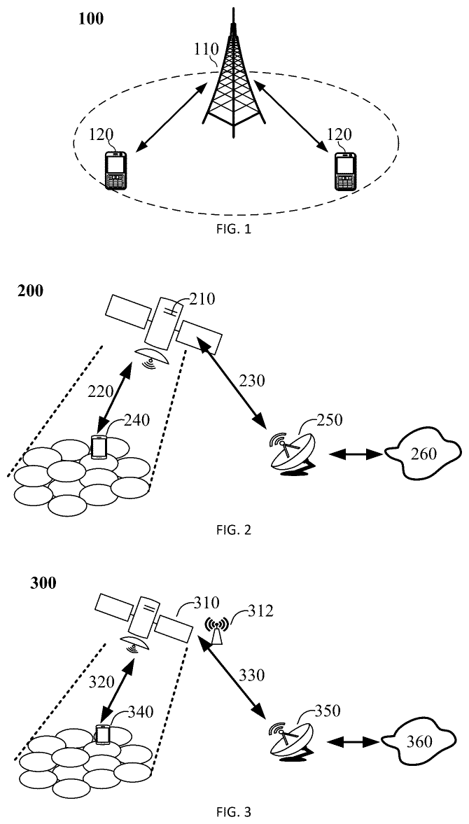

Exemplarily, FIG. 1 is a schematic diagram of an architecture of a communication system provided by an embodiment of the present disclosure. As shown in FIG. 1, the communication system 100 includes a network device 110, which may be a device for communicating with a terminal device 120 (or referred to as a communication terminal). The network device 110 may provide communication coverage for a specific geographical area and communicate with terminal devices located within the coverage area.

FIG. 1 exemplarily shows one network device and two terminal devices. In some embodiments of the present disclosure, the communication system 100 may include multiple network devices, and the coverage area of each network device may include terminal devices with other number, which is not limited by the embodiments of the present disclosure.

Exemplarily, FIG. 2 is a schematic diagram of an architecture of the NTN system mentioned above. The NTN system 200 shown in FIG. 2 uses a satellite 210 as an aerial platform. As shown in FIG. 2, the satellite radio access network includes a satellite 210, a service link 220, a feeder link 230, a terminal device 240, a gateway (GW) 250, and a network 260 including a base station and a core network.

The satellite 210 is a spacecraft based on a space platform. The service link 220 refers to the link between the satellite 210 and the terminal device 240. The feeder link 230 refers to the link between the gateway 250 and the satellite 210. The earth-based gateway 250 connects the satellite 210 to a base station or a core network, depending on the choice of architecture.

The NTN architecture shown in FIG. 2 is a bent-pipe transponder architecture. In the architecture, the base station is located on the earth behind the gateway 250, and the satellite 210 acts as a relay. The satellite 210 operates as a repeater that forwards the signal of the feeder link 230 to the service link 220, or forwards the signal of the service link 220 to the feeder link 230. That is, the satellite 210 does not have the functions of a base station, and the communication between the terminal device 240 and the base station in the network 260 can be relayed through the satellite 210.

Exemplarily, FIG. 3 is a schematic diagram of another architecture of the NTN system. As shown in FIG. 3, the satellite radio access network 300 includes a satellite 310, a service link 320, a feeder link 330, a terminal device 340, a gateway 350, and a network 360. Different from FIG. 2, there is a base station 312 on the satellite 310, and the network 360 behind the gateway 350 only includes a core network.

The NTN architecture shown in FIG. 3 is a regenerative transponder architecture. In the architecture, the satellite 310 is provided with a base station 312 and can be directly connected to the earth-based core network through a link. The satellite 310 has the functions of a base station, and the terminal device 340 can communicate directly with the satellite 310. Therefore, the satellite 310 may be referred to as a network device.

The communication systems with the architectures shown in FIG. 2 and FIG. 3 may include multiple network devices, and the coverage area of each network device may include terminal devices with other number, which is not limited by the embodiments of the present disclosure.

In the embodiments of the present disclosure, any of the communication systems in FIG. 1 to FIG. 3 may include other network entities such as a mobility management entity (MME) and an access and mobility management function (AMF), which is not limited by the embodiments of the present disclosure.

It should be understood that, in the embodiments of the present disclosure, devices with communication functions in the network/system may be referred to as communication devices. Taking the communication system 100 shown in FIG. 1 as an example, the communication device includes the network device 110 and the terminal device 120 with communication functions. The network device 110 and the terminal device 120 may be the specific devices described above, which will not be described herein. The communication device may also include other devices in the communication system 100, such as a network controller, a mobility management entity, and other network entities, which is not limited by the embodiments of the present disclosure.

In order to facilitate understanding, some related technical knowledge involved in the embodiments of the present disclosure will be introduced first. The following related technologies, as optional solutions, may be combined with the technical solutions of the embodiments of the present disclosure in any way, and all of them fall within the protection scope of the embodiments of the present disclosure. The embodiments of the present disclosure include at least some of the following content.

With the development of communication technologies, communication systems (such as 5G) will integrate the market potential of satellite and terrestrial network infrastructure. For example, NTN, including the satellite segment, becomes a recognized part of the 3rd generation partnership project (3GPP) 5G connection infrastructure by the 5G standard.

NTN refers to a network or network segment that uses radio frequency (RF) resources on a satellite or a unmanned aerial system (UAS) platform. Taking satellites as an example, communication satellites are classified into low earth orbit (LEO) satellites, medium earth orbit (MEO) satellites, geostationary earth orbit (GEO) satellites, high elliptical orbit (HEO) satellites, etc., according to different orbital altitudes. Among them, LEO is an earth-centered orbit with an altitude of 2000 kilometers or less, or at least 11.25 periods per day and an eccentricity of less than 0.25. Most artificial objects in outer space are located in LEO. The LEO satellite orbits the earth at high speed (mobility) but in a predictable or determined orbit.

Satellites with different orbital altitudes have different orbital periods.

LEO: the typical altitude ranges from 250 kilometer to 1500 kilometers, and the orbital period ranges from 90 minutes to 120 minutes.

MEO: the typical altitude ranges from 5000 kilometers to 25000 kilometers, and the orbital period ranges from 3 hours to 15 hours.

GEO: The altitude is substantially 35786 kilometers, and the orbital period is 24 hours.

As can be seen from FIG. 2 and FIG. 3, which takes a satellite as an example, the typical scenario of an NTN system accessing a terminal device involves an NTN transparent payload or an NTN regenerative payload. Among them, the bent-pipe transponder architecture shown in FIG. 2 corresponds to the NTN transparent payload, and the regenerative transponder architecture shown in FIG. 3 corresponds to the NTN regenerative payload.

With the development of mobile communication technology, the coverage problem has gradually emerged and attracted wide attention from the industry. In some communication systems, the uplink coverage performance of the terminal devices faces great challenges. For example, in the NR system, due to the higher path loss in the high-frequency band compared to the low-frequency band, and the 5G system is committed to improving the user experience rate and cell edge rate, higher requirements are put forward for the coverage performance. For another example, in the NTN system, round trip time (RTT) from the terminal device to the satellite is very long, and the satellite moves along the orbit, which also puts forward higher requirements for the coverage performance.

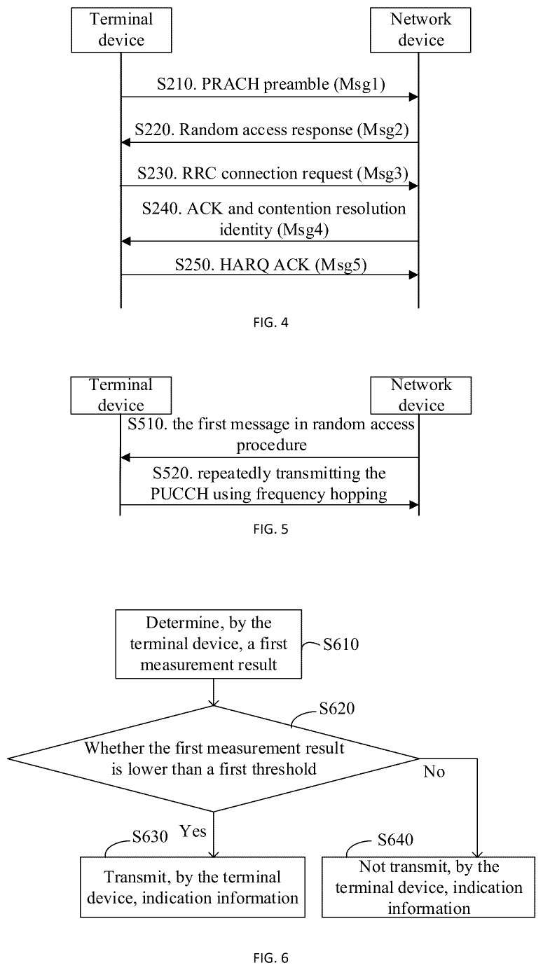

Taking the random access procedure in the communication system as an example, the performance problem of uplink coverage is described in combination with FIG. 4.

FIG. 4 is described from the perspective of the interaction between the terminal device and the network device. The terminal device is, for example, a UE, and the network device is, for example, a base station (gNB). The random access procedure shown in FIG. 4 includes operations S410 to S450. The operations S410 to S440 are the 4-step random access channel (RACH) process.

In S410, a terminal device transmits a message 1 (Msg1) to a network device.

The Msg1 includes a preamble. The terminal device may select a RACH resource and a preamble, and transmit the Msg1 to the network device on the selected resource. The RACH resource may also be referred to as a physical random access channel (PRACH) resource. The preamble in the Msg1 may also be referred to as a PRACH preamble.

In S420, the network device transmits a message 2 (Msg2) to the terminal device.

The Msg2 is also known as a random access response (RAR). The Msg2 may be transmitted through a physical downlink control channel (PDCCH) and a physical downlink shared channel (PDSCH).

After the terminal device transmits the preamble, it monitors the PDCCH within a RAR time window. The terminal device receives the RAR scheduled by the PDCCH scrambled with the random access-radio network temporary identifier (RA-RNTI) by monitoring the PDCCH. The RA-RNTI is related to the time-frequency resource of the RACH used by the terminal device to transmit Msg1. After the terminal device receives the PDCCH, it can decode the PDCCH using the RA-RNTI.

The RAR scheduled by the PDCCH may include various types of information. For example, the sub-header of the RAR may include a back-off indication, which is configured to indicate the back-off time for re-transmitting the Msg1. For another example, the random access preamble identifier in the RAR indicates a preamble index received by the network device in response. For another example, the RAR may include a timing advance group (TAG), which is configured to adjust the uplink timing. For another example, the RAR may include an uplink grant (UL grant), which is configured to schedule the uplink resource indication for a Msg3. Alternatively, the RAR may include a temporary cell-radio network temporary identifier (TC-RNTI). The initially-accessing terminal device may use the TC-RNTI to decode the PDCCH of a Msg4.

The preamble index in the RAR is used by the terminal device to determine whether the reception is successful. If the preamble index in the RAR received by the terminal device is the same as the preamble index transmitted by the terminal device itself, the terminal device considers that it has successfully received the RAR. After the terminal device successfully receives the RAR, it may stop monitoring the RAR and perform operation S430 according to a grant indication in the RAR.

In S430, the terminal device transmits a message 3 (Msg3) to the network device.

The terminal device may transmit the Msg3 on the UL grant scheduled by the network device. The Msg3 may also be referred to as a RRC connection request message.

As mentioned above, the RAR may indicate physical uplink shared channel (PUSCH) resources for the Msg3. Therefore, the Msg3 is transmitted on the uplink shared channel (UL-SCH) and supports the hybrid automatic repeat reQuest (HARQ) mechanism. The PDCCH is scrambled by the TC-RNTI indicated by the RAR, and the re-transmission of the Msg3 is scheduled by the downlink control information (DCI) format.

The Msg3 includes a unique identity (ID) for each terminal device. The identity of the terminal device may be used for contention resolution in operation S440. The terminal device may also transmit a RRC handover confirmation message and a cell-radio network temporary identifier (C-RNTI) through the Msg3.

In S440: the network device transmits a message 4 (Msg4) to the terminal device.

After receiving the Msg3, the network device schedules the Msg4 using the DCI scrambled with the TC-RNTI. The Msg4 may include a contention resolution identity (CRID) and acknowledge (ACK) information. The Msg4 may be transmitted via the PDCCH and the PDSCH. The CRID may be indicated by a media access control (MAC) control element.

When the UE contention resolution identity MAC control element included in the Msg4 successfully decoded by the terminal device matches the UE contention resolution identity transmitted by the Msg3, the terminal device considers the random access successful. Further, the terminal device sets the TC-RNTI carried in the RAR to the C-RNTI, thus completing the 4-step random access.

In 450: the terminal device transmits a message 5 (Msg5) to the network device.

The Msg5 may include HARQ ACK information for the feedback of the Msg4. The Msg5 may be carried in the PUCCH. After the network device transmits the Msg4 during the random access procedure, the terminal device may feed back whether the Msg4 is correctly received (Msg5) through the PUCCH.

As can be seen from FIG. 4, the entire random access procedure starts the radio resource control (RRC) connection only after the terminal device receives the Msg4 and transmits the HARQ feedback. That is, whether the Msg4 is successfully transmitted determines whether the terminal device can access the network. Since the Msg5 includes the feedback of the Msg4, whether the Msg5 is successfully transmitted is directly related to the establishment or re-establishment of the RRC connection.

As mentioned above, the Msg5 (the ACK feedback of the Msg4) is transmitted through the PUCCH. The terminal device needs to determine the uplink resources for transmitting the PUCCH, so as to transmit the Msg5.

In the RRC connected state, the scheduling of the PUCCH resources may be dynamically indicated to the terminal device by the DCI. However, the scheduling mechanism of the PUCCH resources is unavailable before the establishment of the RRC connection. That is, before the RRC connection is established, the terminal device cannot obtain the dedicated PUCCH configuration.

In the initial access stage, the terminal device can only use the cell-level PUCCH configuration configured within the initial uplink (UL) bandwidth part (BWP). After the RRC connection is established, the terminal device has the dedicated PUCCH resource and can then use the corresponding dedicated PUCCH resource.

Exemplarily, the terminal device may determine a common PUCCH resource set according to the PUCCH resource configuration number notified by a system information block1 (SIB1). In the common PUCCH resource set, the terminal device may determine a PUCCH resource by combining the DCI and a control channel element (CCE).

In some protocols (e.g., the NR protocol), the physical resource of the PUCCH during the random access procedure are configured based on the broadcast messages. The physical resource may include at least one physical resource block (PRB).

In the protocols, the PUCCH resource set is predefined before the dedicated PUCCH resources are configured, as shown in Table 1. The resource set shown in Table 1 includes 16 PUCCH resource subset configurations. Based on the predefined resource set table (Table 1), the terminal device may determine which resource subset to use according to the DCI indication and the calculation formula.

TABLE 1

| | PUCCH | First | Number of | PRB | Set of Initial cyclic |
|---|---|---|---|---|---|
| Index | format | symbol | symbols | offset | shift indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |

Referring to Table 1, the first parameter (index) may indicate which resource subset to use. The first parameter may also be referred to as the row index of the table. Each row in Table 1 corresponds to a set of fixed configurations, including the PUCCH format, the first symbol, the number of symbols (continuous symbols), the PRB offset (denoted as

$${RB}_{BWP}^{offset} ) ,$$

and the set of initial cyclic shift (CS) indexes.

$${N}_{BWP}^{size}$$

represents the size of the bandwidth part.

The NR system can support five PUCCH formats. The five PUCCH formats may be classified into short-format and long-format according to the number of symbols occupied in the time domain. The short-format occupies 1-2 symbols and can carry 1-2 bits of information, and the long-format occupies 4-14 symbols and can carry more than 2 bits of information. The purpose of introducing the short-format PUCCH in the NR system is to shorten the delay of the HARQ-ACK feedback, and the long-format is to ensure coverage during the long duration. In addition, considering the flexibility of system configuration, the NR system further supports frequency hopping configuration for the PUCCH with 2 or more symbols. The terminal device may use intra-slot or inter-slot frequency hopping for channel transmission.

The random access procedure and the relevant configuration modes of the PUCCH resources are described above.

During the random access procedure, the network device and the terminal device can resolve the contention caused by the fact that multiple terminal devices in a cell simultaneously transmit the same preamble by exchanging messages (the Msg3 and the Msg4). The Msg3 is transmitted by the terminal device to the network device through the uplink channel.

In the initial access stage, the terminal device cannot perform complex channel measurement or beam training processes. Therefore, the coverage performance of the uplink coverage is worse than the coverage performance of the PDSCH or the PUSCH in the connected state. Since the coverage performance of the Msg3 is worse than the coverage performance of other channels, it may be difficult for the terminal devices in areas with poor signal coverage quality to access the cell.

In order to improve the coverage performance of the Msg3, some communication systems (such as the NR system) have introduced the mechanism of multiple transmission of the Msg3. Multiple transmission is a very effective solution to improve the quality of signal transmission. Repeated transmission of the signal can enhance the detection and decoding performance of the receiver.

As mentioned above, whether the Msg5 is successfully transmitted is also directly related to the success rate of the random access. It can be understood that the Msg5 transmitted through PUCCH also faces the problem of poor coverage performance of the Msg3.

Furthermore, in some communication systems with large transmission delays, the time for the entire random access procedure also increases. For these systems, whether the terminal device can successfully access the system is an important performance index. For example, the RTT of the NTN system is very long, and the message transmission takes a long time, so it is important to ensure the success rate of the random access.

In order to ensure the success rate of the random access in the NTN system, the coverage performance of data transmission in the initial access stage can be improved. Exemplarily, in the NTN system, the method of repeatedly transmitting the PUCCH (Msg5) can be used to increase the success rate of the terminal devices accessing the NTN cell. That is, the success rate of the random access is ensured by supporting the repeated transmission of the PUCCH.

As can be seen from the above, in the RRC connected state, the network device can configure the PUCCH resources for each terminal device and the number of PUCCH repetition in each resource through the dynamic indication of the PUCCH resources. Exemplarily, the base station (e.g., gNB) may indicate the number of repetitions of the same PUCCH to the terminal device by the DCI.

Since the mechanism of dynamic indication through DCI is unavailable before the RRC connection is established, it is necessary to introduce a mechanism for indicating the repeated transmission of the ACK (Msg5) through the PUCCH before the RRC connection is established.

Furthermore, before the RRC connection is established, the terminal device generally has not been configured with dedicated PUCCH resources. Therefore, the terminal device needs to determine the resources for repeated transmission of the PUCCH within the common PUCCH resource set. When repeated transmission of the PUCCH is introduced, the terminal device also needs to separately determine the transmission resources for multiple identical PUCCHs. However, the PUCCH resources determined based on Table 1 and the calculation formula are not necessarily applicable to the determination of the PUCCH repeated transmission resources. It can be seen that before the RRC connection is established, the repeated transmission of the PUCCH puts forward more requirements for the allocation of uplink resources of the PUCCH.

In addition, if the terminal device supports PUCCH repetition in the RRC non-connected state, the network device needs to know whether the terminal device supports the repeated transmission of the Msg5 (PUCCH HARQ for the Msg4). As an example, during the uplink transmission in the random access procedure, the terminal device can inform the network device whether it supports the repeated transmission of the Msg5. The network device then determines the transmission resources and/or the number of repeated transmission of the terminal device based on the information provided by the terminal device. Therefore, how to allocate resources under different circumstances also needs to be considered.

In summary, after the introduction of repeated transmission of the PUCCH, how to allocate the uplink resources of the PUCCH and how the terminal device determines the resources for multiple identical PUCCHs are urgent problems to be solved.

It should be noted that the problem of how to allocate resources for the repeated transmission of the PUCCH in the initial access stage mentioned above is just an example. The embodiments of the present disclosure are applicable to any type of scenario involving the problem of how to allocate PUCCH repeated transmission resources before the RRC connection.

Based on this, the embodiments of the present disclosure propose a method for wireless communication. Through this method, the terminal device can repeatedly transmit the PUCCH in a frequency hopping format. Furthermore, the terminal device can determine a first resource for repeatedly transmitting the PUCCH based on the number of transmission of the PUCCH and/or the first offset related to the repeated transmission, thus improving resource utilization while ensuring duration and coverage performance.

The method for wireless communication provided by the embodiments of the present disclosure is described in detail in combination with FIG. 5. The method shown in FIG. 5 is introduced from the perspective of the interaction between the terminal device and the network device. The terminal device and the network device can be any communication devices in the communication systems mentioned above. For example, the terminal device may be a device that establishes an RRC connection with a network device through a random access request.

In some embodiments, the terminal device and the network device are communication devices in the NTN system. As an example, the network device is carried on a satellite in the NTN. The terminal device may be a ground-based device that applies for communication with the network device on the satellite. As an example, when the satellite serves as a relay, both the terminal device and the network device are ground-based devices that communicate via the satellite.

It should be noted that regardless of whether the network device is carried on a satellite, the network device can communicate with the terminal device via the satellite. That is, the network device can be related to the satellite. As an example, the satellite related to the network device may be a satellite that provides services to a quasi-geostationary fixed cell or a quasi-geostationary mobile cell.

As an example, the terminal device repeatedly transmits the PUCCH to the network device. Correspondingly, the network device may receive the repeatedly transmitted PUCCH from the terminal device via the satellite.

In some embodiments, the terminal device may perform random access under various states. In some cases, the terminal device may perform initial access in a RRC idle state. In some embodiments, the terminal device may perform resume access in a RRC inactive state.

The terminal device and the network device may establish connections in various application scenarios. Such scenarios include, for example, a RRC connection re-establishment scenarios, other system information (SI) request scenarios, and a handover scenario.

Referring to FIG. 5, in S510, the network device transmits the first message in the random access procedure to the terminal device. Correspondingly, the terminal device receives the first message in the random access procedure.

The random access procedure may be a contention-based random access procedure, a non-contention-based random access procedure, or a random access procedure with the terminal device in different states or in various application scenarios, which is not limited herein.

The first message may be a message exchanged between the network device and the terminal device in the random access procedure before the RRC connection is established or re-established. In some embodiments, the first message may be the Msg4 shown in FIG. 4 transmitted by the network device to the terminal device, or it may be the Msg2 shown in FIG. 4. In some embodiments, the first message may be the RAR transmitted by the network device based on the non-contention-based random access method.

In S520, the terminal device repeatedly transmits the PUCCH using frequency hopping. The PUCCH is configured to carry the feedback information corresponding to the first message.

The PUCCH may be the uplink control channel transmitted by the terminal device after receiving the first message. Exemplarily, the PUCCH may be an uplink control channel for transmitting the Msg3 or the Msg5 in FIG. 4 when the terminal device performs initial access.

The PUCCH may carry the feedback information corresponding to the first message. The feedback information may be the HARQ feedback of the first message or other information to confirm the reception of the first message. For example, after receiving the Msg4, the terminal device may transmit the HARQ ACK for the Msg4 through the PUCCH. As another example, after receiving the Msg2, the terminal device may transmit confirmation information related to the RAR through the PUCCH.

In some embodiments, the PUCCH may also carry other information related to random access. For example, when the PUCCH is configured to carry the Msg5, it may also carry information related to the RRC connection.

The terminal device repeatedly transmits the PUCCH using frequency hopping, which means that the terminal device uses frequency hopping to transmit each repetition of the PUCCH within one time slot, or means that the terminal device uses frequency hopping to transmit each repetition of the PUCCH within multiple time slots, which is not limited herein.

In some embodiments, the transmission of the PUCCH may apply the frequency hopping mechanism in each time slot. When the PUCCH is repeatedly transmitted based on the frequency hopping mechanism, it is beneficial to enhancing the uplink duration and coverage. Especially in the random access procedure of the NTN system, configuring the frequency hopping format to feedback the HARQ-ACK for the Msg4 is beneficial to improving the success rate of random access.

As an example, when the PUCCH resource index indicated by the DCI or the CCE ranges from 0 to 7, a first hop of the PUCCH may be located at a lower edge of the configured initial uplink BWP, and a second hop of the PUCCH may be located at an upper edge of the configured initial uplink BWP. When the PUCCH resource index indicated by the DCI or the CCE ranges from 8 to 15, a first hop of the PUCCH may be located at an upper edge of the configured initial uplink BWP, and a second hop of the PUCCH may be located at a lower edge of the configured initial uplink BWP.

As an example, the frequency hopping may be considered for a certain time slot in which the PUCCH is transmitted. For example, the data transmitted in the first half of the time slot may be transmitted on any PRB resource in the initial uplink BWP, and the data transmitted in the second half of the time slot may be transmitted on another PRB resource in the initial uplink BWP.

The resource on which the terminal device repeatedly transmits the PUCCH based on frequency hopping may be referred to as the first resource. That is, the first resource of the PUCCH is used for the repeated transmission of the PUCCH. Therefore, the first resource may be an uplink resource. For example, the terminal device repeatedly transmits the PUCCH on the first resource based on frequency hopping. As another example, the terminal device repeatedly transmits the PUCCH based on frequency hopping on the first resource.

In some embodiments, the first resource is the time-frequency resource for the terminal device to repeatedly transmit multiple identical PUCCHs. As an example, the first resource includes one or more PUCCH resources for the repeated transmission of the PUCCH. For example, when the number of transmission of the PUCCH is N, the first resource includes N PUCCH resources.

As an example, the N repeatedly transmitted PUCCHs are in one-to-one correspondence with the N PUCCH resources.

In some embodiments, the first resource includes multiple PRBs. For example, each of one or more PUCCH resources in the first resource includes one or more PRBs. For another example, in the first resource transmitted based on frequency hopping, any PUCCH resource may include a first PRB in a first hop and a second PRB in a second hop.

In some embodiments, the network device needs to configure the first resource for repeatedly transmitting the PUCCH for each terminal device. Exemplarily, different terminal devices in the NTN cell respectively correspond to different first resources.

In some embodiments, the first resource may belong to the common PUCCH resources mentioned above. Since the first resource is used for the transmission of the PUCCH before the RRC connection is established, the terminal device may determine the first resource based on the configured common PUCCH resource set.

As an example, when the network device needs to reserve common resources for the transmission of the PUCCH of each terminal device in the NTN cell, there may be a problem of insufficient common resources. In order to solve the problem, common resources for repeated transmission of the PUCCH may be increased.

In some embodiments, the first resource may be a dedicated resource (proprietary resource) of the terminal device. Although the RRC establishment is not completed, the PDSCH in the Msg4 may configure different numbers of transmissions for each terminal device and allocate dedicated resources for repeated transmission of the PUCCH for each terminal device.

The first resource for repeated transmission of the PUCCH may be determined according to various information. The information may include the information used to determine the single-transmission resource of the PUCC in relevant protocols, and may also include one or more of the following information: a number of transmission of the PUCCH, a first offset for repeated transmission of the PUCCH. In the following, the determination method of the first resource will be exemplarily described in combination with calculation formulas.

The number of transmission of the PUCCH refers to the number for repeated transmission of the same PUCCH, and thus can be denoted as

$${N}_{PUCCH}^{repeat} .$$

Exemplarily, the number of transmissions may be the number of repetition (number of repeated transmission) of the PUCCH, or it may be determined based on the number of repeated transmission of the PUCCH.

In some embodiments, the number of transmission of the PUCCH may be any one of multiple numbers of transmission configured by the system.

As an example, the number of transmission of the PUCCH is one of 1, 2, 4, 8. For example, the number of repeated transmission of the PUCCH carrying the HARQ-ACK for the Msg4 is 1, 2, 4, or 8. When the number of transmission of the PUCCH is 1, the PUCCH is not repeatedly transmitted. As another example, the number of transmission of the PUCCH may also be other positive integers except 1, 2, 4, and 8.

In some embodiments, the number of transmission of the PUCCH may be configured by the system information block (SIB). When the network device configures the number of transmission of the PUCCH by the SIB, the SIB may be indicated in various ways, which is not limited herein.

As an example, the SIB may directly indicate the number of transmission of a PUCCH. The terminal device may perform the repeated transmission of the PUCCH according to the number of transmission of the PUCCH.

As an example, the SIB may indicate a set of numbers of transmission of the PUCCH. The terminal device may select one value from the set of numbers of transmission of the PUCCH for the repeated transmission of the PUCCH.

As another example, the SIB may indicate relevant information for determining the number of the transmission of the PUCCH. After the terminal device determines the number of the transmission of the PUCCH based on the relevant information, it may perform the repeated transmission of the PUCCH.

In some embodiments, the number of the transmission of the PUCCH may be related to one or more of the following information: one or more repetition factors configured by the network device, a position or a path loss of the terminal device, and a capability of the terminal device. The relevant information for determining the number of the transmission of the PUCCH may include one or more kinds of information, and may also include information other than the one or more kinds of information.

In some embodiments, the number of the transmission of the PUCCH may be determined according to the one or more repetition factors configured by the network device. The repetition factor may be equal to the number of the transmission of the PUCCH, or may be used to calculate the number of the transmission of the PUCCH, which is not limited herein.

As an example, if multiple repetition factors are configured, the terminal device may dynamically indicate the repetition factor in the Msg4 scheduled by the DCI until a dedicated PUCCH resource is configured for the terminal device. That is, if there is no dedicated PUCCH resource, the terminal device repeatedly transmits the PUCCH with HARQ-ACK information on the common PUCCH resources according to the indication of the repetition factor. If there is a dedicated PUCCH resource, the terminal device transmits on the dedicated PUCCH resource.

As one implementation, if the common PUCCH resources are used for dynamic PUCCH repetition, the network device may indicate one or more repetition factors through system information.

As one implementation, the network device may configure the repetition factor of the PUCCH by the SIB. For example, the network device may configure a repetition factor set {2, 4, 8} through SIB, and then indicate a single value among the repetition factor set to configure the repetition factor.

As an example, based on the indication of a number of PUCCH for Msg4 HARQ-ACK repetitions list, the terminal device may determine the number of time slots for repeatedly transmitting the PUCCH with HARQ-ACK information. Herein, the number of PUCCH for Msg4 HARQ-ACK repetitions list is indicated in PUCCH-ConfigCommon.

As one implementation, the network device may indicate the repetition factor of the PUCCH by a downlink assignment index (DAI) bits of the DCI. For example, if multiple values from the set {1, 2, 4, 8} are configured and indicated via the SIB, then one of the multiple values is indicated in the DAI field of DCI format 1_0. The cyclic redundancy check (CRC) of the DCI format 1_0 is scrambled by the TC-RNTI that schedules the reception of the PDSCH.

As an example, if the number of PUCCH for Msg4 HARQ-ACK repetitions list provides multiple values, the DAI field in the DCI format 1_0 indicates

$${N}_{PUCCH}^{repeat}$$

in the multiple values.

As one implementation, if the network device configures multiple repetition factors, the terminal device may select the number of transmission of the PUCCH from the set on its own and inform the network device.

In some embodiments, regarding the repeated transmission of the PUCCH, multiple repetition factors may be simultaneously supported in a specific cell. Exemplarily, different terminal devices in an NTN cell may have the same or different number of repeated transmission. That is, the numbers of transmission of the PUCCH for the terminal devices in the NTN cell may be the same or different.

In some embodiments, the number of transmission of the PUCCH may be determined according to the position or the path loss of the terminal device, so as to improve the uplink coverage performance of terminal devices at different positions. Exemplarily, for the terminal devices in different positions within an NTN cell, the requirements for uplink coverage performance may vary, so different numbers of transmission of the PUCCH may be set. Exemplarily, when the path losses of terminal devices are different, the requirements for uplink coverage may also be different. The path loss of a terminal device may be related to its position, transmission path, and surrounding environment.

In some embodiments, the number of transmission of the PUCCH may be determined according to the capability of the terminal device. When the terminal device supports the repeated transmission of the PUCCH, the capability of the terminal device determines the maximum number of repeated transmission of the PUCCH. The terminal device or the network device may determine the actual number of transmission of the PUCCH based on the capability.

As one implementation, the higher layer may determine the number of transmission of the PUCCH according to the capability of the terminal device.

In some embodiments, the number of transmission of the PUCCH may be determined based on various types of information. Exemplarily, the network device may configure multiple repetition factors, and the terminal device may determine the number of transmission of the PUCCH by itself according to its capability or position. Exemplarily, the network device may determine the number of transmission of the PUCCH based on the capability information and resource status reported by the terminal device.

The first offset for the repeated transmission of the PUCCH may be different from the offset for the single-transmission of the PUCCH. That is, the first offset is not equivalent to the PRB offset in Table 1. Exemplarily, the network device may additionally configure a new offset parameter, namely the first offset, for the repeated transmission of the PUCCH via higher-layer signaling. For example, the first offset may be an additionally configured PRB offset.

In some embodiments, the first offset may be a resource block (RB) offset. The RB offset for the repeated transmission of the PUCCH is different from the RB offset for the single transmission of the PUCCH transmitted by the terminal device.

In some embodiments, the first offset may be a PRB offset used to determine the PUCCH repeated transmission resource.

As an implementation, the network device may provide an additional PRB offset in PUCCH-ConfigCommon, which is denoted as

$$R {B}_{BWP}^{offset \_ Repetition} . R {B}_{BWP}^{offset \_ Repetition}$$

may serve as the PRB offset for any transmission resource in the repeated transmission of the PUCCH. For example, a new column may be added to Table 1 to indicate the first offset.

As an implementation, the network device may configure an additional first offset for multiple transmissions of the PUCCH via higher-layer signaling. If an additional PRB offset is provided, the terminal device may also determine the precise PRB offset based on the configured PUCCH repetition factor.

As an example, the network device may configure a single additional PRB offset via higher-layer signaling. The terminal device may determine the additional PRB offset for each configured PUCCH repetition factor. That is, the conventional PRB offset is used for single PUCCH transmission, and the additional PRB offset is used for repeated transmission of the PUCCH. For example, the additional PRB offset is used for the transmission of multiple PUCCHs corresponding to the first value in the number of PUCCH for Msg4 HARQ-ACK repetitions list. For example, the higher-layer signaling is SIB.

In some embodiments, the first offset includes multiple offsets corresponding to multiple transmissions of the PUCCH in the repeated transmission, and the multiple offsets are the same. As an example, the multiple offsets are in one-to-one correspondence with the multiple PUCCH transmissions. In this scenario, the network device or higher-layer signaling may only configure one first offset without considering the number of repeated transmissions, which is beneficial to resource allocation.

As an implementation, the terminal device may determine multiple PUCCH resources according to the first offset and the number of transmission of the PUCCH.

As an implementation, regardless of whether each terminal device in the NTN cell repeatedly transmits the PUCCH for the same number of times, the first resource may be determined based on a specific or determined re-transmission PRB offset. That is, the PRB offset for each repeated transmission of each terminal device is the same.

As an implementation, the multiple offsets included in the first offset may be different. That is, for each terminal device, the PRB offset for each repeated transmission may be different. In this scenario, the terminal device may directly determine multiple PUCCH resources according to the multiple offsets in the first offset. For example, if multiple repetition factors need to be supported simultaneously in a specific cell, an additional PRB offset may be configured/determined for each PUCCH repetition factor.

In some embodiments, the first offset may also be determined according to one or more of the following information: a position of the terminal device, and a service type of the terminal device.

As an implementation, the terminal devices at different positions within a cell correspond to different first offsets, which can ensure the uplink coverage of the terminal devices at different positions. For example, for each terminal device in an NTN cell, the first offset may be configured correspondingly according to the position of the terminal device.

As an example, the first offset determined based on different positions may be represented as

$$R {B}_{BWP}^{offset \_ Repetition , i} ,$$

where i represents a natural number. Optionally, i represents different position sequences or different position groups. For example, after grouping different areas of an NTN cell, K position groups may be obtained.

$$R {B}_{BWP}^{offset \_ Repetition , i}$$

represents the first offset of the i-th group where the terminal device is located, with i∈[1,K].

As an implementation, the terminal devices of different service types correspond to different first offsets. That is, when the terminal devices of different service types perform random access, the PUCCH resources have different re-transmission PRB offsets. For example, different first offsets are configured for different service characteristics in the NTN cell.

As an example, the first offset determined based on different service types is represented as

$$R {B}_{BWP}^{offset \_ Repetition , j} ,$$

where j represents a natural number. Optionally, j represents different service types. For example, when there are Q service types in an NTN cell,

$$R {B}_{BWP}^{offset \_ Repetition , j}$$

represents the first offset of the terminal device of the j-th service type, with j∈[1,Q].

In combination with FIG. 5, various ways for the terminal device or the network device to determine the first resource for the repeated transmission of the PUCCH are described above. Before determining the first resource, it is also necessary to determine whether the terminal device has the capability to repeatedly transmit the PUCCH to avoid resource waste.

Whether the terminal device has the capability to repeatedly transmit the PUCCH may refer to whether the terminal device supports PUCCH repetition in the RRC non-connected state. That is, when the network device cannot configure a dedicated resource of the PUCCH for the terminal device via DCI, whether the terminal device can perform repeated transmission of the PUCCH.

Exemplarily, if the terminal device has the capability to repeatedly transmit the PUCCH, the network device schedules resources for the terminal device for repeated transmission, so as to improve the success rate of random access of the terminal device.

Exemplarily, if the terminal device does not have the capability to repeatedly transmit the PUCCH, the network device does not allocate resources for repeated transmission to the terminal device, nor do it wait for reception, thus reducing resource waste.

In some embodiments, the information reported by the terminal device to the network device indicating whether the terminal device has the capability to repeatedly transmit the PUCCH may be referred to as indication information. That is, the terminal device reports its capability by the indication information. The indication information indicates whether the terminal device has the capability to repeatedly transmit the PUCCH.

As an example, the indication information directly indicates that the terminal device has the capability to repeatedly transmit the PUCCH. If the terminal device does not transmit the indication information, it indicates that the terminal device does not have the capability, or it indicates that although the terminal device has the capability, it does not perform repeated transmission of the PUCCH.

As an example, the terminal device indicates its PUCCH repetition capability in the MAC sub-header of the Msg3.

In some embodiments, the terminal device directly transmits the indication information to the network device during the uplink transmission of the random access, or determine whether to transmit the indication information to the network device based on certain conditions, so as to reduce resource waste.

As an example, the terminal device determines whether to transmit the indication information to the network device according to a first measurement result and a first threshold. For example, if the first measurement result is lower than the first threshold, the terminal device transmits the indication information to the network device. That is, if the first measurement result indicates that the channel quality is good and there is no need to repeatedly transmit the PUCCH, the capability of transmitting the indication information is not needed, which is beneficial to save resources.

As an implementation, the first measurement result is the channel quality or the signal quality detected by the terminal device during the initial access process. The terminal device determines the first measurement result by detection.

As an implementation, the first measurement result is reference signal received power (RSRP), or other parameters indicating the channel quality or the signal quality, which are not limited herein.

As an implementation, when the number of transmission of the PUCCH is configured by the SIB, the SIB is also used to configure the first threshold. Alternatively, the network device configures the first threshold and the number of transmission of the PUCCH by the SIB.

As an example, the SIB directly indicates the first threshold or indicates relevant information for the terminal device to determine the first threshold.

As an example, regardless of whether the number of transmission of the PUCCH is configured by the SIB, the SIB is used to configure the first threshold. That is, even if the SIB does not configure the number of transmission of the PUCCH, the first threshold is still determined by the configuration of the SIB.

As an example, the network device receives the indication information transmitted by the terminal device, so as to configure the number of transmission of the PUCCH and the first resource according to the capability information of the terminal device. The first threshold is used by the terminal device to determine whether to transmit the indication information.

As an implementation, when the first measurement result is an RSRP value, the first threshold is a RSRP threshold. If the first threshold is configured, the terminal device only indicates its capability when a down-link RSRP is lower than the configured first threshold.

Exemplarily, if an RSRP threshold is configured, only when the measured RSRP value is lower than the configured RSRP threshold, the terminal device with PUCCH re-transmission capability reports the indication information via the PUSCH in the Msg3. Exemplarily, if no RSRP threshold is configured, the terminal device with PUCCH re-transmission capability directly reports the indication information via the PUSCH in the Msg3.

In order to facilitate understanding, an exemplary description of the transmitting process of the indication information will be given with reference to FIG. 6.

Referring to FIG. 6, in S610, the terminal device determines a first measurement result.

In S620, the terminal device determines whether the first measurement result is lower than the first threshold. If the first measurement result is lower than the first threshold, S630 is executed. If the first measurement result is not lower than the first threshold, S640 is executed.

In S630, the terminal device transmits the indication information to the network device.

In S640, the terminal device does not transmit the indication information.

After the terminal device transmits the indication information, the network device may configure the first resource for repeated transmission of the PUCCH for the terminal device based on the method described above. The terminal device may also determine the first resource based on the same method and use frequency hopping to repeatedly transmit the PUCCH.

As can be seen from the above, the first resource may be related to the number of transmission of the PUCCH and/or the first offset. An exemplary description of the method for determining the first resource is given in combination with specific calculation formulas. Herein, the number of transmission of the PUCCH may be N. N may be less than or equal to

$${N}_{PUCCH}^{repeat}$$

described above.

In some embodiments, an index value of the first PRB and an index value of the second PRB in the first resource are related to the first offset and/or a n-th transmission among the N transmissions of the PUCCH, with n∈[0,N−1].

As an example, the index value of the first PRB is the PRB index value of the first hop for the PUCCH transmission, and the index value of the second PRB is the PRB index value of the second hop for the PUCCH transmission.

As an example, the index value of the first PRB is the lowest RPB index of the PUCCH transmission resource within the first frequency hopping. The index value of the second PRB is the lowest PRB index of the PUCCH transmission resource within the second frequency hopping.

In some embodiments, the index value of the first PRB and the index value of the second PRB are determined according to the PUCCH resource index r_{PUCCH}. r_{PUCCH} represents the PUCCH resource index calculated by the terminal device based on the scheduling information.

As an example, r_{PUCCH} is be related to the index in the first column of Table 1.

Exemplarily, 0≤r_{PUCCH}≤15 and

$${r}_{PUCCH} = ⌊ \frac{2 \cdot {n}_{CCE , 0}}{{N}_{CCE}} ⌋ + 2 \cdot {Δ}_{PRI} .$$

N_{CCE} represents the number of CCEs in the control resource set (CORESET) of the DCI format in the PDCCH, n_{CCE,0} represents the index of the first CCE used for PDCCH reception, and APRI represents the value of the PUCCH resource indicator field in the DCI format.

In some embodiments, the RB offset for repeated transmission of the PUCCH refers to the original RB offset of the terminal device. That is, the network device does not configure an additional first offset for repeated transmission of the PUCCH.

Exemplarily, in the n-th transmission, the index value of the first PRB and the index value of the second PRB are as follows respectively:
if └r_{PUCCH}/8┘=0, the index value of the first PRB is

$$( n + 1 ) \cdot R {B}_{BWP}^{offset} \cdot {N}_{RB} + ⌊ {r}_{PUCCH} / {N}_{CS} ⌋ \cdot {N}_{RB} ,$$

and the index value of the second PRB is

$${N}_{BWP}^{size} - ( n + 1 ) \cdot R {B}_{BWP}^{offset} \cdot {N}_{RB} - ( 1 + ⌊ {r}_{PUCCH} / {N}_{CS} ⌋ ) \cdot {N}_{RB} ;$$

and

if └r_{PUCCH}/8┘=1, the index value of the first PRB is

$$( n + 1 ) \cdot R {B}_{BWP}^{offset} \cdot {N}_{RB} + ⌊ ( {r}_{PUCCH} - 8 ) / {N}_{CS} ⌋ \cdot {N}_{RB} ,$$

and the index value of the second PRB is

$${N}_{BWP}^{size} - ( n + 1 ) \cdot R {B}_{BWP}^{offset} \cdot {N}_{RB} - ( 1 + ⌊ ( {r}_{PUCCH} - 8 ) / {N}_{CS} ⌋ ) \cdot {N}_{RB} .$$

Further, the terminal device may determine the initial cyclic shift indexes according to the following formula:

$$if ⌊ {r}_{PUCCH} / 8 ⌋ = 0 , {r}_{PUCCH} mod {N}_{CS} , and if ⌊ {r}_{PUCCH} / 8 ⌋ = 1 , ( {r}_{PUCCH} - 8 ) mod {N}_{CS} .$$

Where n∈[0,N−1],

$$R {B}_{BWP}^{offset}$$

represents a PRB offset, N_{RB} represents a number of RBs in a PUCCH resource set, N_{CS} represents a total number of initial cyclic shift index numbers in a set of initial cyclic shift indexes, and

$${N}_{BWP}^{size}$$

represents a size of a bandwidth part.

As an example, the value of

$$R {B}_{B W P}^{offset}$$

refers to the values corresponding to the column of PRB Offset in Table 1.

As an example, N_{RB} is related to the frequency range (FR). In FR1, N_{RB}=1. In FR2, pucch-ResourceCommon can provide multiple values of N_{RB} for the PUCCH resource set.

In some embodiments, the RB offset for repeated transmission of the PUCCH is the first offset or determined based on the first offset. That is, the first resource is determined according to the number of transmission of the PUCCH and the first offset.

As an implementation, in the n-th transmission, the index value of the first PRB and the index value of the second PRB can be as follows respectively:

if └r_{PUCCH}/8┘=0, the index value of the first PRB is

$$( R {B}_{B W P}^{offset} + n \times R {B}_{B W P}^{offset \_ Repetition} ) \cdot {N}_{R B} + ⌊ {r}_{PUCCH} / {N}_{C S} ⌋ \cdot {N}_{R B} ,$$

and the index value of the second PRB is

$${N}_{B W P}^{s i z e} - ( R {B}_{B W P}^{offset} + n \times {RB}_{B W P}^{offset \_ Repetition} ) \cdot {N}_{R B} - ( 1 + ⌊ {r}_{PUCCH} / {N}_{C S} ⌋ ) \cdot {N}_{R B} ;$$

and

if └r_{PUCCH}/8┘=1, the index value of the first PRB is

$$( R {B}_{B W P}^{offset} + n \times {RB}_{B W P}^{offset \_ Repetition} ) \cdot {N}_{R B} + ⌊ ( {r}_{PUCCH} - 8 ) / {N}_{C S} ⌋ \cdot {N}_{R B} ,$$

and the index value of the second PRB is

$${N}_{B W P}^{s i z e} - ( R {B}_{B W P}^{offset} + n \times {RB}_{B W P}^{offset \_ Repetition} ) \cdot {N}_{R B} - ( 1 + ⌊ ( {r}_{PUCCH} - 8 ) / {N}_{C S} ⌋ ) \cdot {N}_{R B} .$$

Further, the terminal device may determine the initial cyclic shift indexes according to the following formula:

$$if ⌊ {r}_{PUCCH} / 8 ⌋ = 0 , {r}_{PUCCH} mod {N}_{C S} , and if$$

$$⌊ {r}_{PUCCH} / 8 ⌋ = 1 , ( {r}_{PUCCH} - 8 ) mod {N}_{C S} .$$

Where

$${RB}_{B W P}^{offset \_ Repetition}$$

represents the first offset, which may be provided in PUCCH-ConfigCommon. Other letters have the same meanings as above, which are not described in detail herein.

As an example,

$${RB}_{B W P}^{offset \_ Repetition}$$

may be the

$${RB}_{B W P}^{offset \_ Repetition , i} or {RB}_{B W P}^{offset \_ Repetition , j} ,$$

or be determined according to

$${RB}_{B W P}^{offset \_ Repetition , i} and {RB}_{B W P}^{offset \_ Repetition , j} .$$

As another implementation, in the n-th transmission, the index value of the first PRB and the index value of the second PRB can be as follows respectively:
if └r_{PUCCH}/8┘=0, the index value of the first PRB is

$$( n + 1 ) \cdot ( {RB}_{B W P}^{offset} + {RB}_{B W P}^{offset \_ Repetition} ) \cdot {N}_{R B} + ⌊ {r}_{PUCCH} / {N}_{C S} ⌋ \cdot {N}_{R B} ,$$

and the index value of the second PRB is

$${N}_{B W P}^{s i z e} - ( n + 1 ) \cdot ( {RB}_{B W P}^{offset} + {RB}_{B W P}^{offset \_ Repetition} ) \cdot {N}_{R B} - ( 1 + ⌊ {r}_{PUCCH} / {N}_{C S} ⌋ ) \cdot {N}_{R B} ;$$

if └r_{PUCCH}/8┘=1, the index value of the first PRB is

$$( n + 1 ) \cdot ( {RB}_{B W P}^{offset} + {RB}_{B W P}^{offset \_ Repetition} ) \cdot {N}_{R B} + ⌊ ( {r}_{PUCCH} - 8 ) / {N}_{C S} ⌋ \cdot {N}_{R B} ,$$

and the index value of the second PRB is

$${N}_{B W P}^{s i z e} - ( n + 1 ) \cdot ( {RB}_{B W P}^{offset} + {RB}_{B W P}^{offset \_ Repetition} ) \cdot {N}_{R B} - ( 1 + ⌊ ( {r}_{PUCCH} - 8 ) / {N}_{C S} ⌋ ) \cdot {N}_{R B} .$$

Further, the terminal device may determine the initial cyclic shift indexes according to the following formula:

$$if ⌊ {r}_{PUCCH} / 8 ⌋ = 0 , {r}_{PUCCH} mod {N}_{C S} , and if$$

$$⌊ {r}_{PUCCH} / 8 ⌋ = 1 , ( {r}_{PUCCH} - 8 ) mod {N}_{C S} .$$

The meanings of the letters are as described above and will not be repeated herein.

Through the above three different calculation formulas, the network device can allocate the first resource to the terminal device. The terminal device can also determine the first resource and perform the repeated transmission of the PUCCH.

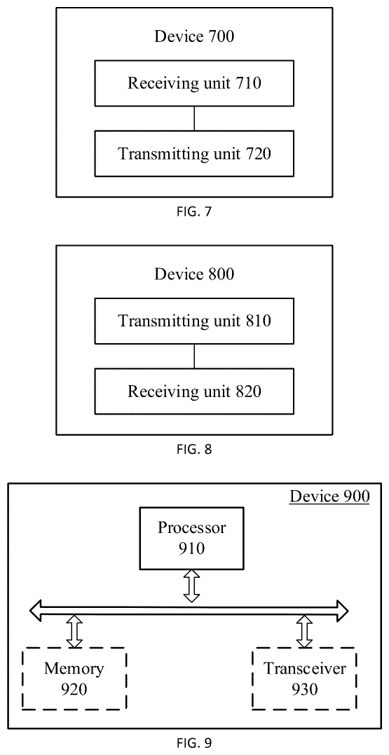

The method embodiments of the present disclosure have been described in detail above in conjunction with FIG. 1 to FIG. 6. The device embodiments of the present disclosure will be described in detail in conjunction with FIG. 7 to FIG. 9. It should be understood that the description of the device embodiments corresponds to the description of the method embodiments. Therefore, for parts not described in detail, reference can be made to the previous method embodiments.

FIG. 7 is a schematic block diagram of a device for wireless communication according to an embodiment of the present disclosure. The device may be any of the terminal devices described above. The device 700 shown in FIG. 7 includes a receiving unit 710 and a transmitting unit 720.

The receiving unit 710 is configured to receive the first message in the random access procedure.

The transmitting unit 720 is configured to repeatedly transmit a PUCCH using frequency hopping, and the PUCCH is configured to carry feedback information corresponding to the first message. A first resource of the PUCCH is determined according to one or more of the following information: a number of transmission of the PUCCH, and a first offset for repeatedly transmitting the PUCCH.

In some embodiments, the device 700 further includes a determination unit, which is configured to determine a first measurement result. The transmitting unit 720 is further configured to transmit indication information to the network device if the first measurement result is lower than a first threshold. The indication information is configured to indicate that the terminal device has a capability of repeatedly transmitting the PUCCH.

In some embodiments, the number of transmission of the PUCCH is configured by a system information block (SIB), and the SIB is further configured to configure the first threshold.

In some embodiments, the number of transmission of the PUCCH is one of 1, 2, 4 and 8.

In some embodiments, the number of transmission of the PUCCH is related to at least one of the following information: at least one repetition factor configured by the network device; a position or a path loss of the terminal device; and a capability of the terminal device.

In some embodiments, the first resource includes at least one PUCCH resource for repeatedly transmitting the PUCCH, and the at least one PUCCH resource includes a first physical resource block (PRB) in a first hop and a second PRB in a second hop.

In some embodiments, the number of transmission of the PUCCH is N, and an index value of the first PRB and an index value of the second PRB are related to a n-th transmission among the N transmissions of the PUCCH, with n∈[0, N−1].

In some embodiments, in the n-th transmission, the index value of the first PRB and the index value of the second PRB are determined according to a PUCCH resource index r_{PUCCH},

if └r_{PUCCH}/8┘=0, the index value of the first PRB is

$$( n + 1 ) \cdot {RB}_{BWP}^{offset} \cdot {N}_{RB} + ⌊ {r}_{PUCCH} / {N}_{CS} ⌋ \cdot {N}_{RB} ,$$

and the index value of the second PKB is

$${N}_{BWP}^{size} - ( n + 1 ) \cdot {RB}_{BWP}^{offset} \cdot {N}_{RB} - ( 1 + ⌊ {r}_{PUCCH} / {N}_{CS} ⌋ ) \cdot {N}_{RB} ;$$

and

if └r_{PUCCH}/8┘=1, the index value of the first PRB is

$$( n + 1 ) \cdot {RB}_{BWP}^{offset} \cdot {N}_{RB} + ⌊ ( {r}_{PUCCH} - 8 ) / {N}_{CS} ⌋ \cdot {N}_{RB} ,$$

and the index value of the second PRB is

$${N}_{BWP}^{size} - ( n + 1 ) \cdot {RB}_{BWP}^{offset} \cdot {N}_{RB} - ( 1 + ⌊ {r}_{PUCCH} - 8 / {N}_{CS} ⌋ ) \cdot {N}_{RB} .$$

Where 0≤r_{PUCCH}≤15,

$${RB}_{BWP}^{offset}$$

represents a PRB offset, N_{RB} represents a number of RBs in a PUCCH resource set, N_{CS} represents a total number of initial cyclic shift index numbers in a set of initial cyclic shift indexes, and

$${N}_{BWP}^{size}$$

represents a size of a bandwidth part.

In some embodiments, the number of transmission of the PUCCH is N, and an index value of the first PRB and an index value of the second PRB are related to a n-th transmission among the N transmissions of the PUCCH, with n∈[0, N−1].

In some embodiments, in the n-th transmission, the index value of the first PRB and the index value of the second PRB are determined according to a PUCCH resource index r_{PUCCH},
if └r_{PUCCH}/8┘=0, the index value of the first PRB is

$$( {RB}_{BWP}^{offset} + n \times {RB}_{BWP}^{offset \_ Repetiton} ) \cdot {N}_{RB} + ⌊ {r}_{PUCCH} / {N}_{CS} ⌋ \cdot {N}_{RB} ,$$

and the index value of the second PRB

$${N}_{BWP}^{size} - ( {RB}_{BWP}^{offset} + n \times {RB}_{BWP}^{offset \_ Repetiton} ) \cdot {N}_{RB} - ( 1 + ⌊ {r}_{PUCCH} / {N}_{CS} ⌋ ) \cdot {N}_{RB} ;$$

and
if └r_{PUCCH}/8┘=1, the index value of the first PRB is

$$( {RB}_{BWP}^{offset} + n \times {RB}_{BWP}^{offset \_ Repetiton} ) \cdot {N}_{RB} + ⌊ ( {r}_{PUCCH} - 8 ) / {N}_{CS} ⌋ \cdot {N}_{RB} ,$$

and the index value of the second PRB is

$${N}_{BWP}^{size} - ( {RB}_{BWP}^{offset} + n \times {RB}_{BWP}^{offset \_ Repetiton} ) \cdot {N}_{RB} - ( 1 + ⌊ ( {r}_{PUCCH} - 8 ) / {N}_{CS} ⌋ ) \cdot {N}_{RB} .$$

Where 0≤r_{PUCCH}≤15,

$${RB}_{BWP}^{offset}$$

represents a PKB offset,

$${RB}_{BWP}^{offset \_ Repetiton}$$

represents the first offset, N_{RB} represents a number of RBs in a PUCCH resource set, N_{CS} represents a total number of initial cyclic shift index numbers in a set of initial cyclic shift indexes, and

$${N}_{BWP}^{size}$$

represents a size of a bandwidth part.

In some embodiments, in the n-th transmission, the index value of the first PRB and the index value of the second PRB are determined according to a PUCCH resource index r_{PUCCH},
if └r_{PUCCH}/8┘=0, the index value of the first PRB is

$$( n + 1 ) \cdot ( {RB}_{BWP}^{offset} + n \times {RB}_{BWP}^{offset \_ Repetiton} ) \cdot {N}_{RB} + ⌊ {r}_{PUCCH} / {N}_{CS} ⌋ \cdot {N}_{RB} ,$$

and the index value of the second PRB is

$${N}_{BWP}^{size} - ( n + 1 ) \cdot ( {RB}_{BWP}^{offset} + n \times {RB}_{BWP}^{offset \_ Repetiton} ) \cdot {N}_{RB} - ( 1 + ⌊ {r}_{PUCCH} / {N}_{CS} ⌋ ) \cdot {N}_{RB} ;$$

if └r_{PUCCH}/8┘=1, the index value of the first PRB is

$$( n + 1 ) \cdot ( {RB}_{BWP}^{offset} + {RB}_{BWP}^{offset \_ Repetiton} ) \cdot {N}_{RB} + ⌊ ( {r}_{PUCCH} - 8 ) / {N}_{CS} ⌋ \cdot {N}_{RB} ,$$

and the index value of the second PRB is

$${N}_{BWP}^{size} - ( n + 1 ) \cdot ( {RB}_{BWP}^{offset} + {RB}_{BWP}^{offset \_ Repetiton} ) \cdot {N}_{RB} - ( 1 + ⌊ ( {r}_{PUCCH} - 8 ) / {N}_{CS} ⌋ ) \cdot {N}_{RB} .$$

Where 0≤r_{PUCCH}≤15,

$${RB}_{BWP}^{offset}$$

represents a PRB offset,

$${RB}_{BWP}^{offset \_ Repetiton}$$

represents the first offset, N_{RB} represents a number of RBs in a PUCCH resource set, N_{CS} represents a total number of initial cyclic shift index numbers in a set of initial cyclic shift indexes, and

$${N}_{BWP}^{size}$$

represents a size of a bandwidth part.

In some embodiments, the first offset includes a plurality of offsets corresponding to a plurality of transmissions of the PUCCH in the repeated transmissions, and the plurality of offsets are identical.

In some embodiments, the first offset is determined based on at least one of the following information: a position of the terminal device, and a service type of the terminal device.

In some embodiments, the transmitting unit 720 is further configured to repeatedly transmit the PUCCH to a satellite in a non terrestrial network (NTN).

FIG. 8 is a schematic block diagram of another device for wireless communication according to an embodiment of the present disclosure. The device may be any of the network devices described above. The device 800 shown in FIG. 8 includes a transmitting unit 810 and a receiving unit 820.

The transmitting unit 810 is configured to transmit a first message in a random access procedure.

The receiving unit 820 is configured to receive a physical uplink channel (PUCCH) using frequency hopping. The PUCCH is configured to carry feedback information corresponding to the first message. A first resource of the PUCCH is determined according to at least one of the following information: a number of transmission of the PUCCH, and a first offset for repeatedly transmitting the PUCCH.

In some embodiments, the receiving unit 820 is further configured to receive indication information transmitted by the terminal device. The indication information is configured to indicate that the terminal device has a capability of repeatedly transmitting the PUCCH. The device further includes a processing unit, configured to allocate the first resource to the terminal device.

In some embodiments, the number of transmission of the PUCCH is configured by a system information block (SIB), the SIB is further configured to configure a first threshold, and the first threshold is used by the terminal device to determine whether to transmit the indication information.

In some embodiments, the number of transmission of the PUCCH is one of 1, 2, 4 and 8.

In some embodiments, the number of transmission of the PUCCH is related to at least one of the following information: at least one repetition factor configured by the network device, a position or a path loss of the terminal device, and a capability of the terminal device.

In some embodiments, the first resource includes at least one PUCCH resource for repeatedly transmitting the PUCCH, and the at least one PUCCH resource includes a first physical resource block (PRB) in a first hop and a second PRB in a second hop.

In some embodiments, an index value of the first PRB and an index value of the second PRB in the first resource are related to a n-th transmission among the N transmissions of the PUCCH, with n∈[0,N−1].

In some embodiments, in the n-th transmission, the index value of the first PRB and the index value of the second PRB are determined according to a PUCCH resource index r_{PUCCH},
if [r_{PUCCH}/8]=0, the index value of the first PRB is

$$( n + 1 ) \cdot {RB}_{BWP}^{offset} \cdot {N}_{RB} + ⌊ {r}_{PUCCH} / {N}_{CS} ⌋ \cdot {N}_{RB} ,$$

and the index value of the second PRB is

$${N}_{BWP}^{size} - ( n + 1 ) \cdot {RB}_{BWP}^{offset} \cdot {N}_{RB} - ( 1 + ⌊ {r}_{PUCCH} / {N}_{CS} ⌋ ) \cdot {N}_{RB} ;$$

and
if └r_{PUCCH}/8┘=1, the index value of the first PRB is

$$( n + 1 ) \cdot {RB}_{BWP}^{offset} \cdot {N}_{RB} + ⌊ ( {r}_{PUCCH} - 8 ) / {N}_{CS} ⌋ \cdot {N}_{RB} ,$$

and the index value of the second PRB is

$${N}_{BWP}^{size} - ( n + 1 ) \cdot {RB}_{BWP}^{offset} \cdot {N}_{RB} - ( 1 + ⌊ ( {r}_{PUCCH} - 8 ) / {N}_{CS} ⌋ ) \cdot {N}_{RB} .$$

Where 0≤r_{PUCCH}≤15,

$${RB}_{BWP}^{offset}$$

represents a END offset, N_{RB} represents a number of RBs in a PUCCH resource set, Nes represents a total number of initial cyclic shift index numbers in a set of initial cyclic shift indexes, and

$${N}_{BWP}^{size}$$

represents a size of a bandwidth part.

In some embodiments, the number of transmission of the PUCCH is N, and an index value of the first PRB and an index value of the second PRB are related to the first offset and a n-th transmission among the N transmissions of the PUCCH, and n∈[0, N−1].

In some embodiments, in the n-th transmission, the index value of the first PRB and the index value of the second PRB are determined according to a PUCCH resource index r_{PUCCH},
if └r_{PUCCH}/8┘=0, the index value of the first PRB is

$$( {RB}_{BWP}^{offset} + n \times {RB}_{BWP}^{offset \_ Repetiton} ) \cdot {N}_{RB} + ⌊ {r}_{PUCCH} / {N}_{CS} ⌋ \cdot {N}_{RB} ,$$

and the index value of the second PRB is

$${N}_{BWP}^{size} - ( {RB}_{BWP}^{offset} + n \times {RB}_{BWP}^{offset \_ Repetiton} ) \cdot {N}_{RB} - ( 1 + ⌊ {r}_{PUCCH} / {N}_{CS} ⌋ ) \cdot {N}_{RB} ;$$

and
if └r_{PUCCH}/8┘=1, the index value of the first PRB is

$$( {RB}_{BWP}^{offset} + n \times {RB}_{BWP}^{offset \_ Repetiton} ) \cdot {N}_{RB} + ⌊ ( {r}_{PUCCH} - 8 ) / {N}_{CS} ⌋ \cdot {N}_{RB} ,$$

and the index value of the second PRB is

$${N}_{BWP}^{size} - ( {RB}_{BWP}^{offset} + n \times {RB}_{BWP}^{offset \_ Repetiton} ) \cdot {N}_{RB} - ( 1 + ⌊ ( {r}_{PUCCH} - 8 ) / {N}_{CS} ⌋ ) \cdot {N}_{RB} .$$

Where 0≤r_{PUCCH}≤15,

$${RB}_{BWP}^{offset}$$

represents the first offset,

$${RB}_{BWP}^{offset \_ Repetition}$$

represents a number of RBs in a PUCCH resource set, N_{CS} represents a total number of initial cyclic shift index numbers in a set of initial cyclic shift indexes, and

$${N}_{BWP}^{size}$$

represents a size or a bandwidth part.

In some embodiments, in the n-th transmission, the index value of the first PRB and the index value of the second PRB are determined according to a PUCCH resource index r_{PUCCH},
if [r_{PUCCH}/8]=0, the index value of the first PRB is

$$( n + 1 ) \cdot ( {RB}_{BWP}^{offset} + {RB}_{BWP}^{offset \_ Repetition} ) \cdot {N}_{RB} + ⌊ {r}_{PUCCH} / {N}_{CS} ⌋ \cdot {N}_{RB} ,$$

and the index value of the second PRB is

$${N}_{BWP}^{size} - ( n + 1 ) \cdot ( {RB}_{BWP}^{offset} + {RB}_{BWP}^{offset \_ Repetition} ) \cdot {N}_{RB} - ( 1 + ⌊ {r}_{PUCCH} / {N}_{CS} ⌋ ) \cdot {N}_{RB} ;$$

and

if └r_{PUCCH}/8┘=1, the index value of the first PRB is

$$( n + 1 ) \cdot ( {RB}_{BWP}^{offset} + {RB}_{BWP}^{offset \_ Repetition} ) \cdot {N}_{RB} + ⌊ ( {r}_{PUCCH} - 8 ) / {N}_{CS} ⌋ \cdot {N}_{RB} ,$$

and the index value of the second PRB is

$${N}_{BWP}^{size} - ( n + 1 ) \cdot ( {RB}_{BWP}^{offset} + {RB}_{BWP}^{offset \_ Repetition} ) \cdot {N}_{RB} - ( 1 + ⌊ ( {r}_{PUCCH} - 8 ) / {N}_{CS} ⌋ ) \cdot {N}_{RB} .$$

Where 0≤r_{PUCCH}≤15,

$${RB}_{BWP}^{offset}$$

represents a PRB offset,

$${RB}_{BWP}^{offset \_ Repetition}$$

represents the first offset, N_{RB} represents a number of RBs in a PUCCH resource set, N_{CS} represents a total number of initial cyclic shift index numbers in a set of initial cyclic shift indexes, and

$${N}_{BWP}^{size}$$

represents a size of a bandwidth part.

In some embodiments, the first offset includes a plurality of offsets corresponding to a plurality of transmissions of the PUCCH in the repeated transmissions, and the plurality of offsets are identical.

In some embodiments, the first offset is determined based on at least one of the following information: a position of the terminal device, and a service type of the terminal device.

In some embodiments, the receiving unit 820 is further configured to receive the repeatedly transmitted PUCCH via a satellite in a non terrestrial network (NTN).

FIG. 9 is a schematic structural diagram of a communication device according to an embodiment of the present disclosure. The dotted lines in FIG. 9 indicate that the units or modules are optional. The device 900 may be used to implement the methods described in the above-mentioned method embodiments. The device 900 may be a chip, a terminal device, or a network device.

The device 900 may include at least one processor 910. The at least one processor 90 supports the device 900 to implement the method described in the above embodiments for the method. The at least one processor 910 may be a general-purpose processor or a special-purpose processor. For example, the processor is a central processing unit (CPU). Alternatively, the processor may be other general-purpose processor, a digital signal processor (DSP), an application specific integrated circuits (ASIC), a field programmable gate array (FPGA) or other programmable logic device, a discrete gate or a transistor logic device, a discrete hardware component, etc. The general-purpose processor may be a microprocessor or the processor may be any conventional processor, etc.

The device 900 further includes at least one memory 920 storing a program. The program can be executed by the processor 910 to perform the method described in the above embodiments for the method. The memory 920 is independent of or integrated in the processor 910.

The device 900 further includes a transceiver 930. The processor 910 communicates with other devices or chips via the transceiver 930. For example, the processor 910 transmits and receives data with other devices or chips via the transceiver 930.

A computer-readable storage medium configured to store a program is provided by an embodiment of the present disclosure. The computer-readable storage medium is applicable to the terminal device or the network device provided by the embodiments of the present disclosure, and the program causes the computer to perform the method executed by the terminal device or the network device according to the embodiments of the present disclosure.

It should be understood that the computer-readable storage medium mentioned in the embodiments of the present disclosure can be any available medium that a computer can read or a data storage device, such as a server or a data center that integrates at least one available medium. The available medium may be a magnetic medium (such as a floppy disk, a hard disk, or a magnetic tape), an optical medium (such as a digital video disc (DVD)) or a semiconductor medium (such as a solid state disk (SSD)).

A computer program product configured to store a program is provided by an embodiment of the present disclosure. The computer program product includes a program. The computer program product is applicable to the terminal device or the network device provided by the embodiments of the present disclosure, and the program causes the computer to perform the method executed by the terminal device or the network device according to the embodiments of the present application.

The above embodiments can be implemented in whole or in part by software, hardware, firmware or any combination thereof. In case of being implemented in software, the embodiments can be fully or partially implemented in the form of a computer program product. The computer program product includes at least one computer instruction. When the at least one computer program instruction is loaded and executed on a computer, the flow or function described in the embodiments of the present disclosure is generated in whole or in part. The computer can be a general-purpose computer, a special-purpose computer, a computer network, or other programmable devices. The computer instruction can be stored in a computer-readable storage medium or transmitted from one computer-readable storage medium to another computer-readable storage medium. For example, the computer instruction can be transmitted from one website, computer, server or data center to another website, computer, server or data center by a wired way (such as a coaxial cable, an optical fiber, a digital subscriber line (DSL)), or a wireless way (such as infrared, wireless, microwave, etc.).

A computer program is further provided according to an embodiment of the present disclosure. The computer program can be applied to the terminal devices or the network devices provided in the embodiments of the present disclosure, and the computer program causes a computer to execute the methods executed by the terminal devices or the network devices in various embodiments of the present disclosure.

The terms “system” and “network” in the embodiments of the present disclosure may be used interchangeably. In addition, the terms used in the present disclosure are only used to explain the specific embodiment of the present disclosure, and are not intended to limit the present disclosure. The terms “first”, “second”, “third”, and “fourth” used to are used to distinguish between different objects and are not intended to describe a particular order. In addition, the terms “include” and “have”, and any variations thereof, are intended to cover non-exclusive inclusion.

In the embodiments of the present disclosure, the term “indicate” may be a direct indication, an indirect indication, or an association relationship. For example, A indicates to B, which can mean that A indicates to B directly, for example, B can be accessed through A, or it can mean that A indicates to B indirectly, for example, A indicates to C, and that B can be accessed through C, or it can mean that there is an associative relationship between A and B.

In the embodiments of the present disclosure, the term “correspond” can indicate a direct or indirect corresponding relationship between the two, or an associative relationship between the two, or a relationship between indicating and being indicated, or configuring and being configured, and the like.

In the embodiments of the present disclosure, “predefined” or “pre-configured” can be realized by pre-saving the corresponding code, table, or other means of indicating relevant information in a device (e.g., including the terminal device and the network device), which is not limited in the embodiments of the present disclosure.

In the embodiment of the present application, the “protocol” may refer to a standard protocol in the communication field, including, for example, LTE protocol, NR protocol and related protocols applied in future communication systems, which is not limited by the present disclosure.

In the embodiments of the present disclosure, determining B according to A does not mean determining B only according to A, but also according to A and/or other information.

In the embodiments of the present disclosure, the term “and/or” is only an association relationship describing the associated objects, which means that there can be three relationships. For example, A and/or B, which can mean that there are three situations: A, A and B, and B. In addition, the character “/” herein generally indicates an “or” relationship between the associated objects.

In the embodiments of the present disclosure, the magnitude of the reference numerals of the above processes does not imply the order of execution, and the order of execution of the processes should be determined by its function and inherent logic, without any limitation on the process of implementation of the embodiments of the present disclosure.

In the embodiments of the present disclosure, it should be understood that the disclosed system, device and method can be realized in other ways. For example, the embodiments for the device described above are only schematic. For example, the division of the units is only a logical function division. In actual implementation, there may be other division methods, such as a plurality of units or components can be combined or integrated into another system, or some features can be ignored or not implemented. In addition, the coupling or direct coupling or communication connection shown or discussed can be indirect coupling or communication connection through some interfaces, devices or units, which can be electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of the embodiments of the present disclosure.

In addition, each respective functional unit in the embodiments of the present disclosure can be integrated into one processing unit, or each respective unit can exist physically, or two or more units can be integrated into one unit.

The above is only the specific embodiments of the present disclosure, but the protection scope of the present disclosure is not limited thereto. Any variations or substitutions that can be easily conceived by those skilled in the art within the technical scope disclosed by the present disclosure, should be included in the protection scope of the present disclosure. Therefore, the protection scope of the present disclosure should be based on the protection scope of the claims.

What is claimed is:

1. A method, comprising:
receiving, by a terminal device from a non terrestrial network (NTN) network device, a first message in a random access procedure, wherein the first message indicates repetition transmission of a physical uplink control channel (PUCCH), wherein the PUCCH is configured to carry feedback information of a message 4 (Msg4) corresponding to the first message, wherein a first resource of the PUCCH is determined according to at least one of the following information:
a number of repetition transmission of the PUCCH; or
a first offset for repetition transmission of the PUCCH; and
performing repetition transmission of the PUCCH with frequency hopping by using the first resource.

2. The method according to claim 1, wherein the method further comprises:
determining, by the terminal device, a first measurement result; and
in response to the first measurement result being lower than a first threshold, transmitting, by the terminal device, indication information to the NTN network device, wherein the indication information indicates that the terminal device has a capability of repetition transmission of the PUCCH.

3. The method according to claim 2, wherein the number of repetition transmission of the PUCCH and the first threshold are configured by a system information block (SIB).

4. The method according to claim 1, wherein the number of repetition transmission of the PUCCH is one of 1, 2, 4, or 8.

5. The method according to claim 1, wherein the number of repetition transmission of the PUCCH is related to at least one of the following information:
at least one repetition factor configured by the NTN network device;
a position or a path loss of the terminal device; or
a capability of the terminal device.

6. The method according to claim 1, wherein the first resource includes at least one PUCCH resource for repetition transmission of the PUCCH, and the at least one PUCCH resource includes a first physical resource block (PRB) in a first hop and a second PRB in a second hop.

7. The method according to claim 6, wherein the number of transmission of the PUCCH is N, and an index value of the first PRB and an index value of the second PRB are related to a n-th transmission among the N transmissions of the PUCCH, with n∈[0, N−1].

8. The method according to claim 7, wherein in the n-th transmission, the index value of the first PRB and the index value of the second PRB are determined according to a PUCCH resource index r_{PUCCH}, and
when └r_{PUCCH}/8┘=0, the index value of the first PRB is
$$( n + 1 ) \cdot {RB}_{BWP}^{offset} \cdot {N}_{RB} + ⌊ {r}_{PUCCH} / {N}_{CS} ⌋ \cdot {N}_{RB} ,$$
and the index value of the second PRB is
$${N}_{BWP}^{size} - ( n + 1 ) \cdot {RB}_{BWP}^{offset} \cdot {N}_{RB} - ( 1 + ⌊ {r}_{PUCCH} / {N}_{CS} ⌋ ) \cdot {N}_{RB} ;$$
or
when └r_{PUCCH}/8┘=1, the index value of the first PRB is
$$( n + 1 ) \cdot {RB}_{BWP}^{offset} \cdot {N}_{RB} + ⌊ ( {r}_{PUCCH} - 8 ) / {N}_{CS} ⌋ \cdot {N}_{R B} ,$$
and the index value of the second PRB is
$${N}_{BWP}^{size} - ( n + 1 ) \cdot {RB}_{BWP}^{offset} \cdot {N}_{RB} - ( 1 + ⌊ ( {r}_{PUCCH} - 8 ) / {N}_{CS} ⌋ ) \cdot {N}_{R B} ;$$
wherein 0≤r_{PUCCH}≤15,
$${RB}_{BWP}^{offset}$$
represents a PRB offset, N_{RB} represents a number of RBs in a PUCCH resource set, N_{CS} represents a total number of initial cyclic shift index numbers in a set of initial cyclic shift indexes, and
$${N}_{BWP}^{size}$$
represents a size of a bandwidth part.

9. The method according to claim 6, wherein the number of transmission of the PUCCH is N, and an index value of the first PRB and an index value of the second PRB are related to the first offset and a n-th transmission among the N transmissions of the PUCCH, with n∈[0, N−1].

10. The method according to claim 9, wherein in the n-th transmission, the index value of the first PRB and the index value of the second PRB are determined according to a PUCCH resource index r_{PUCCH},
when └r_{PUCCH}/8┘=0 the index value of the first PRB is
$$( {RB}_{BWP}^{offset} + n \times {RB}_{BWP}^{offset \_ Repetition} ) \cdot {N}_{RB} + ⌊ {r}_{PUCCH} / {N}_{CS} ⌋ \cdot {N}_{RB} ,$$
and the index value of the second PRB is
$${N}_{BWP}^{size} - ( {RB}_{BWP}^{offset} + n \times {RB}_{BWP}^{offset \_ Repetition} ) \cdot {N}_{RB} - ( 1 + ⌊ {r}_{PUCCH} / {N}_{CS} ⌋ ) \cdot {N}_{RB} ;$$
or
when └r_{PUCCH}/8┘=1, the index value of the first PRB is
$$( {RB}_{BWP}^{offset} + n \times {RB}_{BWP}^{offset \_ Repetition} ) \cdot {N}_{RB} + ⌊ ( {r}_{PUCCH} - 8 ) / {N}_{CS} ⌋ \cdot {N}_{RB} ,$$
and the index value of the second PRB is
$${N}_{BWP}^{size} - ( {RB}_{BWP}^{offset} + n \times {RB}_{BWP}^{offset \_ Repetition} ) \cdot {N}_{RB} - ( 1 + ⌊ ( {r}_{PUCCH} - 8 ) / {N}_{CS} ⌋ ) \cdot {N}_{RB} ;$$
wherein 0≤r_{PUCCH}≤15,
$${RB}_{BWP}^{offset}$$
represents a PRB offset,
$${RB}_{BWP}^{offset \_ Repetition}$$
represents the first offset, N_{RB} represents a number of RBs in a PUCCH resource set, N_{CS} represents a total number of initial cyclic shift index numbers in a set of initial cyclic shift indexes, and
$${N}_{BWP}^{size}$$
represents a size of a bandwidth part.

11. The method according to claim 9, wherein in the n-th transmission, the index value of the first PRB and the index value of the second PRB are determined according to a PUCCH resource index r_{PUCCH},
when └r_{PUCCH}/8┘=1, the index value of the first PRB is
$$( n + 1 ) \cdot ( {RB}_{BWP}^{offset} + {RB}_{BWP}^{offset \_ Repetition} ) \cdot {N}_{RB} + ⌊ {r}_{PUCCH} / {N}_{CS} ⌋ \cdot {N}_{RB} ,$$
and the index value of the second PRB is
$${N}_{BWP}^{size} - ( n + 1 ) \cdot ( {RB}_{BWP}^{offset} + {RB}_{BWP}^{offset \_ Repetition} ) \cdot {N}_{RB} - ( 1 + ⌊ {r}_{PUCCH} / {N}_{CS} ⌋ ) \cdot {N}_{RB} ;$$
or
when └r_{PUCCH}/8┘=1, the index value of the first PRB is
$$( n + 1 ) \cdot ( {RB}_{BWP}^{offset} + {RB}_{BWP}^{offset \_ Repetition} ) \cdot {N}_{RB} + ⌊ ( {r}_{PUCCH} - 8 ) / {N}_{CS} ⌋ \cdot {N}_{RB} ,$$
and the index value of the second PRB is
$${N}_{BWP}^{size} - ( n + 1 ) \cdot ( {RB}_{BWP}^{offset} + {RB}_{BWP}^{offset \_ Repetition} ) \cdot {N}_{RB} - ( 1 + ⌊ ( {r}_{PUCCH} - 8 ) / {N}_{CS} ⌋ ) \cdot {N}_{RB} ;$$
wherein 0≤r_{PUCCH}≤15,
$${RB}_{BWP}^{offset}$$
represents a PRB offset,
$${RB}_{BWP}^{offset \_ Repetition}$$
represents the first offset, N_{RB} represents a number of RBs in a PUCCH resource set, N_{CS} represents a total number of initial cyclic shift index numbers in a set of initial cyclic shift indexes, and
$${N}_{BWP}^{size}$$
represents a size of a bandwidth part.

12. The method according to claim 1, wherein the first offset includes a plurality of offsets corresponding to a plurality of transmissions of the PUCCH in the repetition transmission, and the plurality of offsets are identical.

13. The method according to claim 1, wherein the first offset is determined based on at least one of the following information:
a position of the terminal device; or
a service type of the terminal device.

14. A method, comprising:
transmitting, by a non terrestrial network (NTN) network device, a first message in a random access procedure, wherein the first message indicates repetition transmission of a physical uplink control channel (PUCCH);
receiving, by the NTN network device from a terminal device, a repetition transmission of PUCCH with frequency hopping, wherein the PUCCH carries feedback information of a message 4 (Msg4) corresponding to the first message;
wherein a first resource of the PUCCH is determined according to at least one of the following information:
a number of repetition transmission of the PUCCH; or
a first offset for repetition transmission of the PUCCH.

15. An apparatus, comprising:
at least one processor;
one or more non-transitory computer-readable storage media coupled to the at least one processor and storing programming instructions for execution by the at least one processor, wherein the programming instructions, when executed, cause the apparatus to perform operations comprising:
receiving, from a non terrestrial network (NTN) network device, a first message in a random access procedure, wherein the first message indicates repetition transmission of a physical uplink control channel (PUCCH), wherein the PUCCH is configured to carry feedback information of a message 4 (Msg4) corresponding to the first message, wherein a first resource of the PUCCH is determined according to at least one of the following information:
a number of repetition transmission of the PUCCH; or
a first offset for repetition transmission of the PUCCH; and
performing repetition transmission of the PUCCH with frequency hopping by using the first resource.

16. The apparatus according to claim 15, wherein the operations further comprise:
determining a first measurement result; and
in response to the first measurement result being lower than a first threshold, transmitting indication information to the NTN network device, wherein the indication information indicates that the apparatus has a capability of repetition transmission of the PUCCH.

17. The apparatus according to claim 16, wherein the number of repetition transmission of the PUCCH and the first threshold are configured by a system information block (SIB).

18. The apparatus according to claim 15, wherein the number of repetition transmission of the PUCCH is one of 1, 2, 4, or 8.

19. The apparatus according to claim 15, wherein the number of repetition transmission of the PUCCH is related to at least one of the following information:
at least one repetition factor configured by the NTN network device;
a position or a path loss of the apparatus; or
a capability of the apparatus.

20. The apparatus according to claim 15, wherein the first resource includes at least one PUCCH resource for repetition transmission of the PUCCH, and the at least one PUCCH resource includes a first physical resource block (PRB) in a first hop and a second PRB in a second hop.
